(19) United States
(12) Patent Application Publication
(10) Pub. No.: US 2013/0179264 A1
(43) Pub. Date: Jul. 11, 2013

(54) SYSTEM AND METHOD FOR GENERATING AND SENDING PROMOTIONAL OFFERS VIA TEXT MESSAGE

(71) Applicant: KYLE J. WILSON, Desoto, KS (US)

(72) Inventor: KYLE J. WILSON, Desoto, KS (US)

(73) Assignee: INTERACTIVE COUPON EXCHANGE, INC., Desoto, KS (US)

(21) Appl. No.: 13/439,608

(22) Filed: Apr. 4, 2012

Related U.S. Application Data
(60) Provisional application No. 61/583,423, filed on Jan. 5, 2012.

(51) Int. Cl. G06Q 30/02

(52) U.S. Cl. 705/14.58; 705/14.49

(57) ABSTRACT

A method for electronically generating and providing promotional offers to a mobile device is provided. Consumer-initiated text messages are directed to a common code. Based on a natural language request from the consumer in the text message, promotional offers matching the consumer request from a group of promotional offers for a number of businesses are identified and sequentially sent in sets to the consumer. Promotional offers are provided based on the location of the consumer.

### CROSS REFERENCE TO RELATED APPLICATIONS

This application claims the benefit of U.S. Provisional Application No. 61/583,423, filed Jan. 5, 2012, entitled “System And Method For Generating And Sending Promotional Offers Via Text Message,” which is hereby incorporated herein by reference.

### FIELD OF THE INVENTION

The present invention relates to mobile communications technologies, and, more particularly, to systems and methods for generating and sending promotional offers to consumers in response to consumer-initiated text messages.

### BACKGROUND

The use of text messaging on mobile phones has changed the manner in which people communicate. However, businesses have struggled to effectively use text messaging to deliver coupons and other promotional offers to mobile phone users for a variety of reasons. For example, the amount and type of promotional content capable of delivery through a text message are limited and traditional coupons are not easily communicated in this format. Attempts to push advertisements to consumers oftentimes are disfavored by consumers as untimely or unwanted. Likewise, systems that require a consumer to request advertisements by sending a specific message to a specific address suffer from complexity and high costs. Other shortcomings are numerous.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Examples of the present invention relate to systems and methods to generate and send promotional offers to consumers in response to consumer-initiated text messages sent to a common short code.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing environment suitable for use in implementing examples of the present invention;

FIG. 2A-2B is a flow diagram showing an exemplary method for electronically generating and providing promotional offers to a mobile device from a computing system of the present invention;

FIG. 3 is an illustrative screen display of a consumer-initiated request;

FIG. 4 is an illustrative screen display requesting review and acknowledgement of terms and conditions prior to receiving promotional offers in accordance with examples of the present invention;

FIG. 5 is an illustrative screen display of a first promotional offer matching the consumer-initiated request;

FIG. 6 is an illustrative screen display of a second promotional offer matching the consumer-initiated request;

FIG. 7 is a block diagram showing an exemplary relationship of promotional offers associated with a plurality of businesses and locations;

FIG. 8 is an illustrative screen display of a first promotional offer for a first business having a single location as exemplified in FIG. 7;

FIG. 9 is an illustrative screen display of a promotional offer associated only with a first location of a business having multiple locations as exemplified in FIG. 7;

FIG. 10 is an illustrative screen display of a promotional offer associated only with a second location of a business having multiple locations as exemplified in FIG. 7;

FIG. 11 is an illustrative screen display of another promotional offer for the first location of a business having multiple locations as exemplified in FIG. 7; and

FIG. 12 is an illustrative screen display of another promotional offer (with common terms to the offer displayed in FIG. 11) associated with the second location of the business having multiple locations.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Instances of the present invention generate and send promotional offers to consumers in response to consumer-initiated text messages sent to a common short code. The promotional offers are provided sequentially to the consumer based on the characteristics of the promotional offers.

Accordingly, in one example, the present invention is directed to a computer storage media having computer-executable instructions embodied thereon that perform a method for electronically generating and providing promotional offers to a mobile device. The method includes receiving a number of consumer-initiated text messages directed to a common code. A number of promotional offers are matched to the consumer request from a group of promotional offers for a number of businesses. Then, a first promotional text message including a subset of matched promotional offers is sent to the consumer. In response to a subsequent text message from the consumer, a second promotional text message including a second subset of matched promotional offers is sent to the consumer. In instances, the location of the consumer is used to filter the matched promotional offers prior to delivery to the consumer.

In yet another example of the invention, the present invention is directed to a computer storage media having computer-executable instructions embodied thereon, that when executed, perform a method for electronically generating and providing promotional offers to a mobile device. The method includes storing a number of promotional offers. Each promotional offer includes one or more keywords, a value of each keyword, a geography associated with the offer, and the content of the offer. In response to a first consumer-initiated text message request to a common code, the method identifies promotional offers based on whether the consumer-initiated text message includes a keyword associated with one or more promotion offers. In the method, the promotional offers are filtered based on the location of the consumer. Next, a first subset of the identified promotional offers is sent to the consumer. Then, in response to a consumer-initiated text message reply, a second subset of identified promotional offers is sent. The value of the promotional offers in the first subset exceeds the value of promotional offers in the second subset.

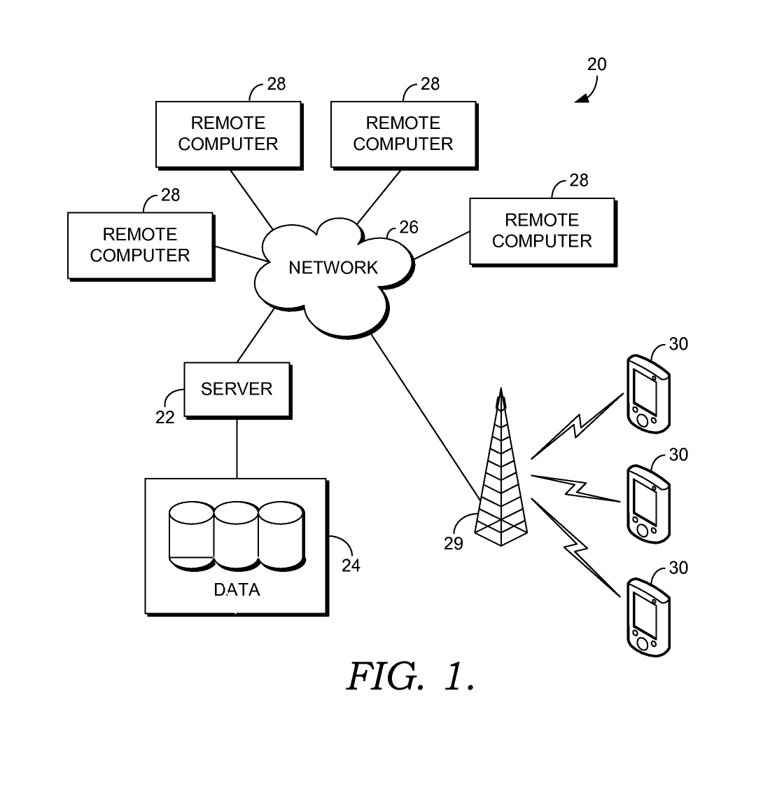

Referring now to the drawings in general, and initially to FIG. 1 in particular, an example of a suitable computing system environment in which the invention may be implemented, for instance, a telecommunications computing system, is illustrated and designated generally as reference numeral 20. It will be understood and appreciated by those of ordinary skill in the art that the illustrated telecommunications information computing system environment 20 is merely an example of one suitable computing environment and is not intended to suggest any limitation as to the scope of use or functionality of the invention. Neither should the telecommunications computing system environment 20 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary telecommunications information computing system environment 20 includes a general purpose computing device in the form of a control server 22. Components of the control server 22 may include, without limitation, a processing unit, internal system memory, and a suitable system bus for coupling various system components, including database cluster 24, with the control server 22. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 22 typically includes therein, or has access to, a variety of computer readable media, for instance, database cluster 24. Computer readable media can be any available media that may be accessed by control server 22, and includes volatile and nonvolatile media, as well as removable and nonremovable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, DVD or other optical disk storage, magnetic cassettes, magnetic tape, magnetic disk storage or other magnetic storage device, or any other medium which can be used to store the desired information and which may be accessed by control server 22. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 24, provide storage of computer readable instructions, data structures, program modules, and other data for control server 22.

The control server 22 may operate in a computer network 26 using logical connections to one or more remote computing devices or computers 28. Remote computers 28 may be personal computers, servers, routers, network PCs, personal digital assistants (PDA), peer devices, other common network nodes, or the like, and may include some or all of the elements described above in relation to the control server 22.

The control server 22 communicates via telecommunication system devices 29 with mobile devices 30 capable of sending and receiving text messages such as MMS, SMS or TMS message. One of an exemplary remote electronic communication devices 30 shown is a portable communications device, such as a PDA, a mobile cellular phone, a mobile text-pager, tablet computing device or a combination thereof.

Exemplary computer networks 26 may include, without limitation, local area networks (LANs) and/or wide area networks (WANs). Such networking environments are commonplace in offices, enterprise-wide computer networks, intranets, and the Internet. When utilized in a WAN networking environment, the control server 22 may include a modem or other means for establishing communications over the WAN, such as the Internet. In a networked environment, program modules or portions thereof may be stored in the control server 22, in the database cluster 24, or on any of the remote computers 28. For example, and not by way of limitation, various application programs may reside on the memory associated with any one or all of the remote computers 28. It will be appreciated by those of ordinary skill in the art that the network connections shown are exemplary and other means of establishing a communications link between the computers (e.g., control server 22 and remote computers 28) may be utilized. In instances, an SMS gateway may be employed to facilitate communication of text messages between the control server and network (i.e., through telecommunications networks) to the mobile devices.

In operation, a user may enter commands and information into the control server 22 or convey the commands and information to the control server 22 via one or more of the remote computers 28 through input devices, such as a keyboard, a pointing device (commonly referred to as a mouse), a trackball, a touch screen, or a touch pad. Other input devices may include, without limitation, microphones, satellite dishes, scanners, or the like. The control server 22 and/or remote computers 28 may include other peripheral input or output devices, such as speakers, a printer, or a scanner.

Although many other internal components of the control server 22 and the remote computers 28 are not shown, those of ordinary skill in the art will appreciate that such components and their interconnection are well known. Accordingly, additional details concerning the internal construction of the control server 22 and the remote computers 28 are not further disclosed herein.

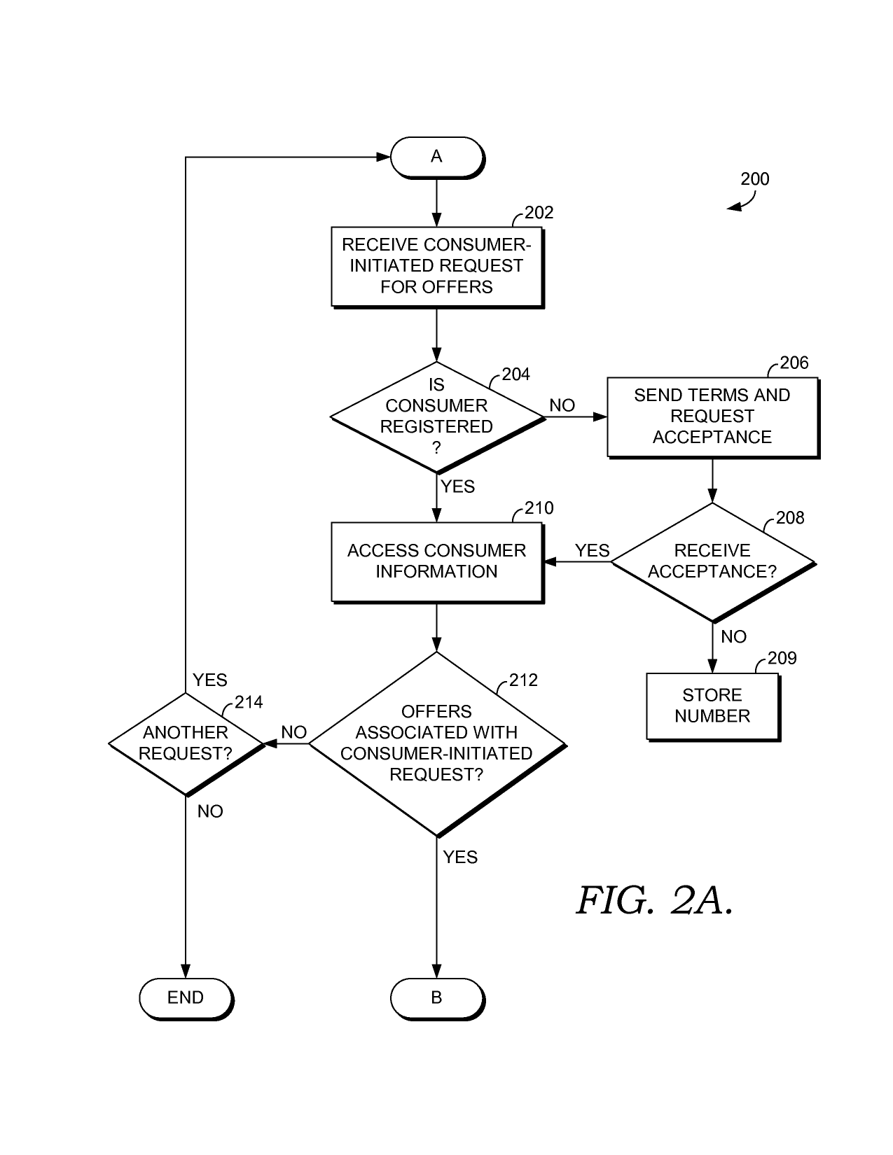

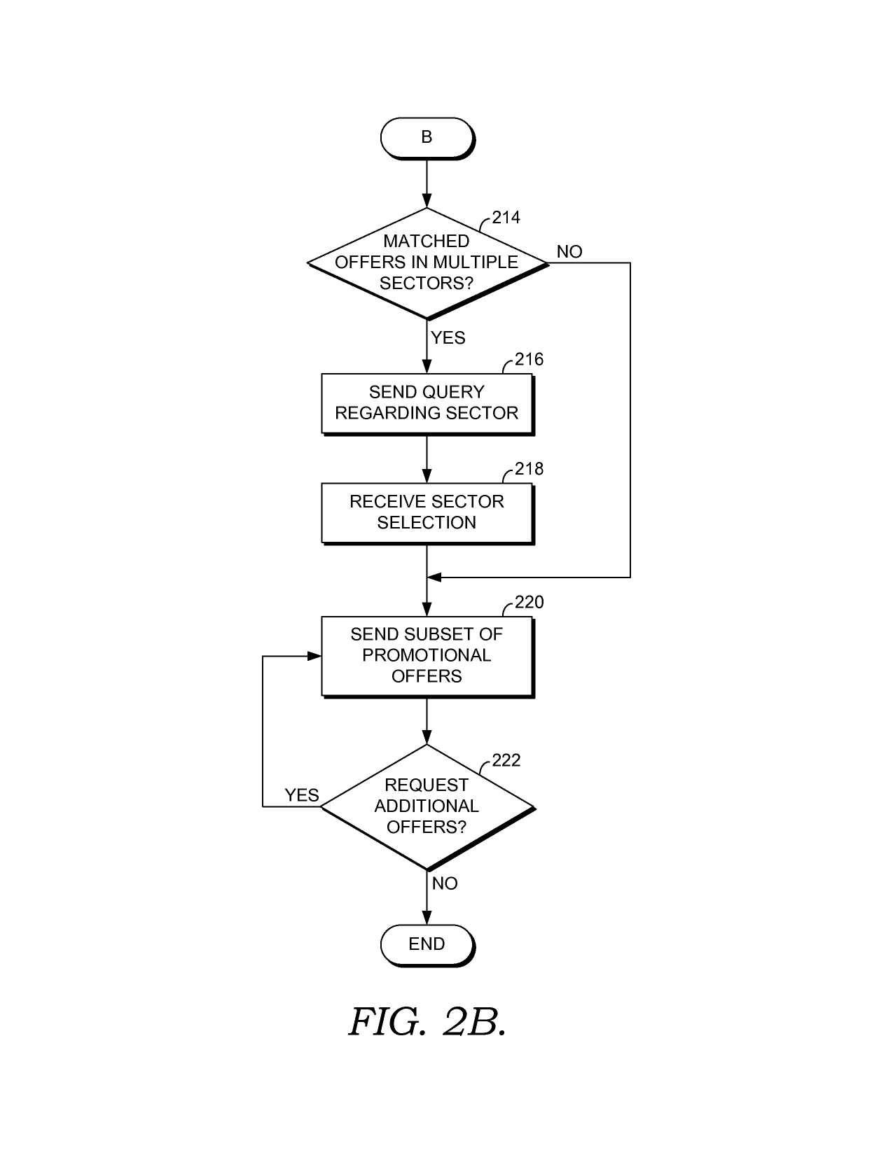

Turning now to FIG. 2, a flow diagram is provided illustrating a method 200 for electronically generating and providing promotional offers to a mobile device. Initially, as represented at step 202, the system receives a consumer-initiated text message requesting promotional offers for a good or service in any of a variety of business sectors.

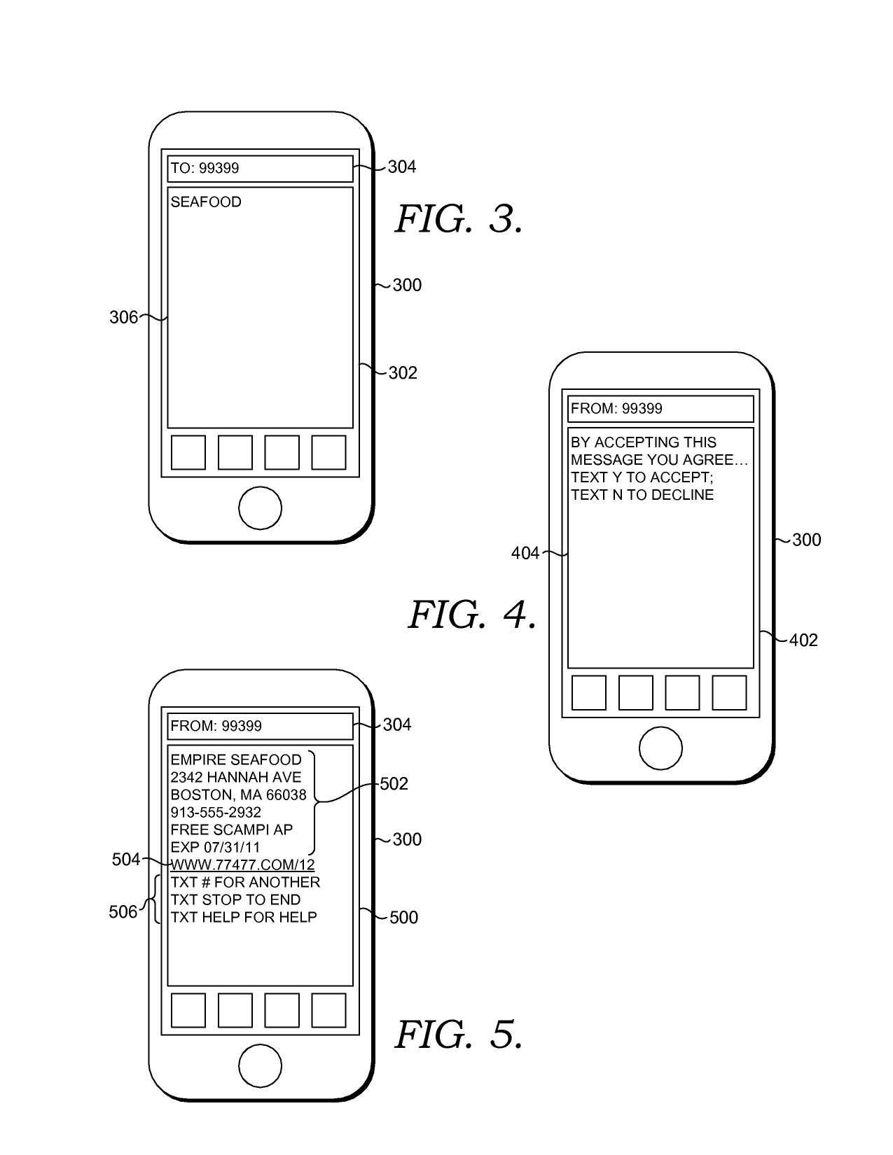

With reference to FIG. 3, a mobile phone 300 is providing including a graphical user display 302 showing a consumer-initiated request. The display 302 includes an address section 304 and a message section 306. A single, universal code is entered into the address section. The same code is used irrespective of the goods and services for which the consumer would like to receive offers. In FIG. 3, the exemplary short code is “99399”. In instances, the address is a string of numbers easily remembered by the consumers to aid the promotion, adoption and use of the systems and methods of the present invention. The address may be entered by use of a keyboard, voice, selection from a menu of stored addresses or any other method known in the art.

In the message section 306, the consumer enters a request in the form of a word, phrase, number or series of numbers that identifies the good or services for which the consumer would like to obtain promotional offers. In instances, the request is free-formed by the consumer in a natural language format. The request may identify a category of goods or services, or the trade name, slogan, service mark, or trademark of a particular supplier, retailer, product or service. The address may be entered by use of a keyboard, voice, selection from a menu of stored addresses or any other method known in the art. As shown in FIG. 3, the request is exemplified as “seafood”.

The consumer-initiated message and the originating mobile phone number are received at block 202 after the consumer transmits the message. In examples, additional information is received. In one instance, the format of the text message is detectable from the message. SMS and MMS are exemplary formats of text messages. The geographical location of the user may be transmitted along with the request. The geographical information from the GPS antennae of the mobile device may be transferred along with the request. Alternatively, the location of the mobile device is determined by triangulation of the device among multiple towers in contact with the mobile device. In addition to device-location information, information regarding the mobile device may be transferred. For example, the type of mobile device or the mobile operating system on the device may be passed along with the consumer-initiated text message.

Next, at block 204, it is determined whether the consumer is registered to receive promotional offers. In instances, the mobile phone number is checked against a list of registered numbers in the database cluster 24. As described in detail below, the consumer's phone number may be registered through an initial transaction with the service. In alternative examples, consumers may register for the service by accepting the terms and conditions through an interactive website, mobile application, email, traditional mail or orally such as by a call to a call center operator.

If the consumer is not registered for the service, the terms and conditions are sent to the consumer via text message at block 206. In instances, the format of the message having the terms and conditions is determined based on the type of text message or mobile device the consumer is using.

With reference to FIG. 4, an exemplary display 402 on the mobile phone 300 of the consumer is shown. The message section 404 of a display 402 displays the terms of the service. Also, the message contains a request for the consumer to send a reply text message of “Y” if the consumer accepts the terms and a message of “N” if the consumer rejects the terms. In another example, the consumer accepts the terms and conditions by providing the location of the consumer. Exemplary locations include the zip code or home address of the consumer. The location is stored in the database cluster for use in generating offers as discussed below. In other examples, the consumer may opt not to allow the use of the consumer's location or opt not to receive certain types of offers.

At block 208, a determination is made whether the consumer accepted the terms and conditions. If the consumer rejects the terms by returning a message or failing to reply within a pre-determined period of time, the mobile phone number of the user is stored at block 210 and offers are not provided to the consumer.

If the consumer is already registered at block 204 or accepts the terms at block 208, information about the consumer is accessed at block 210 prior to generation of the promotional offers. In examples, the consumer information is the last location provided by the consumer or the last location of the consumer. Consumer information may also include consumer preference data regarding the types of offers preferred or disfavored by the consumer. For example, the consumer may provide a list of businesses from which the user would not like to receive promotional offers.

Next, at block 212, a determination is made whether any promotional offers in the database cluster are associated with the consumer-initiated request. In examples, specific words, numbers or phrases (“keywords”) are available for purchase by businesses. Exemplary keywords include business names, tradenames, product trademarks, service marks, business sector, type of business (i.e., restaurant, restaurants, seafood, seafood restaurant, fast food), problem or need (i.e., hungry, hungry for seafood, hungry 4 seafood), menu item (i.e., sushi, calamari, salmon) or the like. In examples, keywords may be any word other than a word used for navigation of the system (i.e., “menu”), certain numbers or number types (i.e., a zip code used to accept terms and conditions), a profane word, certain symbols or other combinations reserved by the administrator of the system. In examples, the keywords are associated with products and services across a variety of sectors such as restaurants, grocery/foods, retail products, automotive, home services, retail services, and professional services so consumers may receive promotional offers for any product or service by sending a text message request to the single short code (i.e., “99399”) from the mobile device.

Each coupon or other promotional offer is associated with one or more keywords. Likewise, each keyword may be associated with any number of promotional offers. A comprehensive library of each keyword and the promotional offers associated with each keyword is stored in the database cluster. In examples, each offer is uniquely identified in the database by a numerical identifier along with the details of the offer. The details include the name of the business supplying the offer, the address of the business, the geographical location of the business, the terms of the offer, the redemption method, device types capable of receiving the offer, the business sector of the offer, and the geography for the applicable offer. The redemption method may include a redemption code that the consumer presents at the point of sale, or an image, text string or bar code representing a coupon to be shown at the point-of-sale. Alternatively, the offer may be a standing offer that does not require any action by the consumer to redeem. In instances, the geography is defined by a proximity radius is a distance (i.e., four miles) from the geographical location of the business and defines the relevant area for potential consumers of the goods or services offered. Alternatively, the geography is definable at the municipality-level such as city, county, burrough or the like.

Each keyword is sold to one or more businesses. When a promotional offer of a business is provided to a consumer as described in detail below, the business is responsible to pay the administrator of the system for the advertising value of the keyword. A number of businesses may purchase the same keyword at various prices. For example, the keyword “seafood” may be associated with many coupons or promotional offers of a variety of restaurants and grocery stores. The keywords may be purchased at a transaction price selected by the businesses, as part of an auction or reverse auction, or any of a variety of market techniques. In one example, businesses provide the maximum value the business is willing to pay for the keyword. The business is charged one cent more than the next highest bid for the keyword so that the business maintains its priority for the word so long as the maximum value is not exceeded. If the next highest bid increases its bid value, then the value assigned to the keyword is increased to maintain priority so long as the value does not exceed the predefined maximum value the business set for the keyword. Likewise, minimum values for a keyword may be imposed, for example, to ensure the hard costs for the text messages are covered. In another example, potential purchasers of a keyword are provided with the first and second highest values that other businesses have paid for the keyword. In other instances, a potential purchaser may be provided with more comprehensive data including correlations of the keyword value and the number of coupons distributed and/or the number of completed transactions for those coupons including verification at the point-of-sale. In other instances, the keyword purchaser may assign a total value to the advertising campaign and a keyword value. When the campaign funds are depleted, then the value resets to zero (or a minimum value).

In instances, the determination at block 212 is made by querying the promotional offer database for a direct match of the request of the consumer to the keywords of the promotional offers. In alternative examples, partial or complete natural language processing (NLP) techniques are employed to identify one or more keywords. For example, a consumer-initiated request for “SEAFOOD OR JAPANESE” may be parsed to return promotional offers for the keywords “SEAFOOD” and “JAPANESE”. In other examples, the NLP technique may link a particular consumer-initiated request to highly correlated synonyms or translate, for example, a request made in Spanish to its equivalent English keyword. In other examples, common misspellings or spacing errors may be considered in selecting one or more keywords. More specifically, the user request may be processed prior to the direct matching process by eliminating leading spaces, removing trailing spaces, reducing multiple spaces to a single space, removing apostrophes or removing punctuation. In other examples, complex NLP techniques may result keywords based on the likelihood of importance to the entirety of the consumer-initiated request and promotional offers distributed (as described below) for those keywords with a certain threshold level of correlation to the consumer-initiated request.

In instances, the submission of a numerical value in a consumer-initiated text messages requires a determination whether the numerical value signifies a zip code registration of a new user or a numerical keyword request for promotional offers. If the consumer is registered in the system, the number is considered as a keyword. If the number is 5 or 8 digits and the consumer is not registered, the system may query the user to determine whether the consumer-initiated request intended to register to receive promotional offers or the number in the offer was a query itself. Alternatively, the system may assume the submission is a request to register the consumer if the terms and conditions were recently sent.

Also, in examples, the determination at block 212 compares location information for the consumer against the geographic location of the promotional offer. In one example, the zip code provided during the user registration is checked against a list of zip codes for the promotional offer. In another example, the geographical radius of the promotional offer is compared to the area defined by the zip code to determine if the two areas overlap with one another. Other geofencing techniques are contemplated by the present invention. In another alternative, the user information is provided along the consumer-initiated request and utilized to determine the consumer location in real-time and compared against the geographical area for the promotional offers. In instances, offers having a defined date range within which the offer is active are identified and those offers outside the defined date range are excluded.

If no offers are associated with the consumer-initiated request, then a text message is sent to the consumer at block 214 to communicate the lack of matching offers and to request the consumer to provide another request (i.e., “Sorry, no matches for your request in your area. Can we try something else?”). If the consumer does not reply in a defined time, the process ends. If the consumer initiates another request, the process starts anew at block 202. In other instances, the process inform the user of deals for other keywords if the original request did not result in any matched deals. In one example, the process may inform the consumer of deals for words likely intended by the request such as for common misspellings (i.e., “There are no deals for ‘Pitza; Did you mean (1) Pizza—15 deals, (2) Stuffed Crust Pizza—8 deals, or (3) Carryout Pizza—5 deals?). In other instances, business logic and/or machine learned (such as through neural networks) may be employed to determine associated keywords and/or categories for deals when the original request did not result in any matched deals. For example, a user request for “Wheels” that did not result in a match may return “We have deals for (1) Tire Repair—5 deals or (2) New Tires—4 deals”.

Additionally, some consumer-initiated requests may contain profanity or other unwanted content as described above. In this instance, the text message returned to the consumer states that the word is not acceptable. In instances, upon a certain number of inappropriate requests, requests from the consumer will no longer be considered by the system.

Next, at block 214, it is determined if the promotional offers matching the consumer-initiated request are in multiple business sectors. By way of example, the promotional offers for the keyword “SEAFOOD” are present in multiple sectors—restaurant and grocery/foods. In instances, at block 216 an initial text message is sent to the consumer to select the desired sector (i.e., reply “1” for restaurant offers or “2” for grocery offers.) Next, the reply text message is received and stored at block 218 prior to sending the matched offers. In other instances, the matched promotional offers are sent as described below without the steps set forth in blocks 214 and 216. In yet another example, the number of matching determines whether the steps set forth in blocks 214 and 216 are performed. For example, if five or less promotional offers match the consumer-initiated request, the system provides the offers as set forth below rather than requiring the consumer to expend the time and effort to select the appropriate business sector.

In another example, prioritization may be determined based, in part, on the prior use behavior of the consumer. In one example, coupon redemption data may be provided and stored in the database cluster. In this example, redemption codes are provided electronically by the merchants and stored in association with the mobile number of the consumer. When the consumer initiates a text message request, promotional offers leading to prior sales to the consumer may be presented first. In another example, the consumer may provide a request to block offers from certain merchants and retailers based on user preference. In these examples, the blocked promotional offers are removed from the set of matched offers prior to sending the promotional offers to the consumer.

Next, at block 220, a first subset of matching promotional offers is sent to the consumer. In examples, the offer with the highest keyword value is sent to the consumer first. With reference to FIG. 5, an exemplary screen display 500 of a promotional offer is illustrated. The display includes a first section 502 with the location of the restaurant and terms of the offer. The first section 502 would be provided irrespective of the device type of the consumer. Section 504 includes an attachment including additional information, for example, a image or URL about the offer or the business. In examples, this section would be provided to consumers using mobile devices with mobile web browsing capabilities. Section 506 of display 500 includes commands for the user to reply to the message. Specifically, the user is instructed to enter “#” for the next matching promotional offer, “STOP” to end the transaction process and “HELP” to receive information regarding the offer or the use of the system.

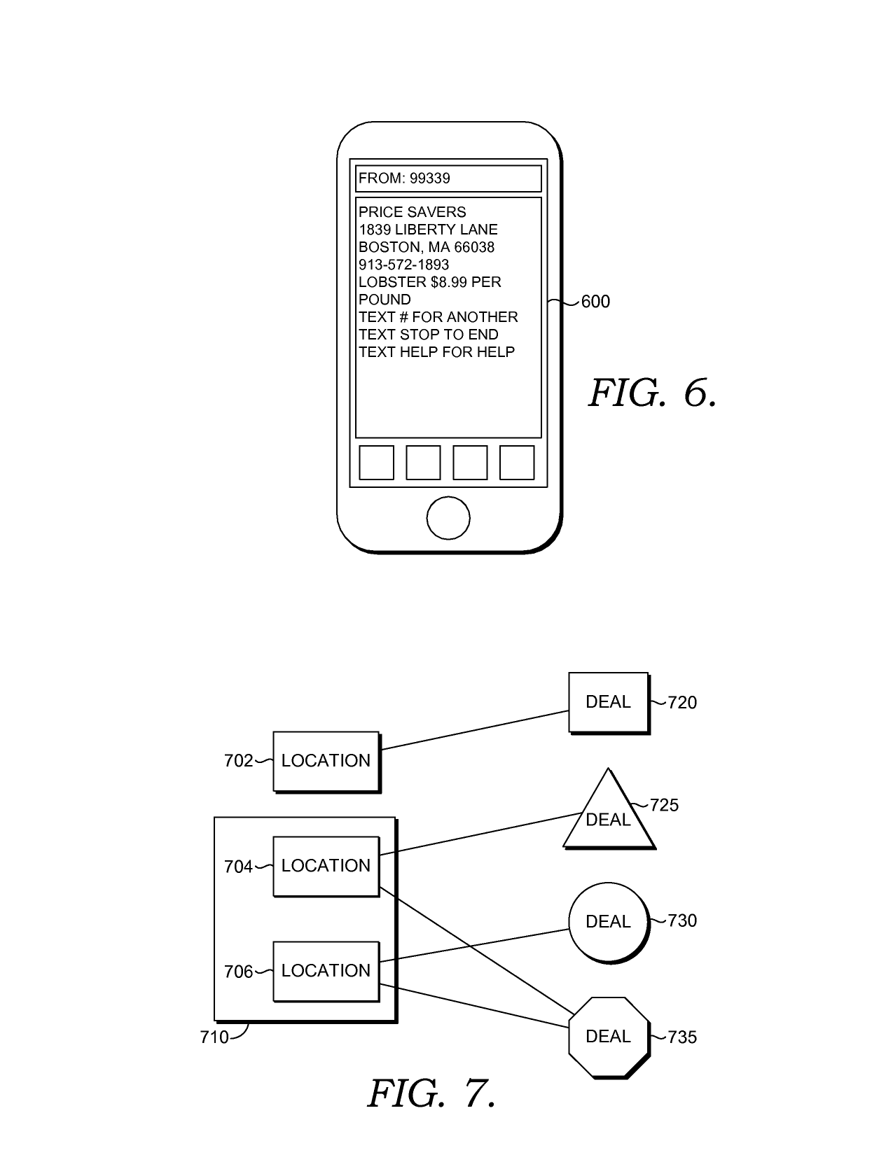

Next, at block 222, a determination is made whether the consumer requests an additional promotional offer matching the consumer-initiated request. For example, upon receipt of a text message from the consumer (i.e., “#”), the next subset of matched promotional offers is provided to the consumer. With reference to FIG. 6, an exemplary screen display 600 of a second promotional offer is illustrated. The display 600 includes another matched offer associated with the keyword “SEAFOOD”. In this example, the offer relates to another sector (i.e., grocery/foods). In examples, the offer of display 600 is displayed sequentially after the promotional offer of FIG. 5 after receipt of the text message from the consumer (i.e., “#”). In other examples, the offer of display 600 may be the first promotional offer displayed after selection of the appropriate business sector as described above. Additional subsets of promotional offers are displayed to the consumer until no further matching promotional offers are available, the user sends a text message directed the process to stop, or no response from the consumer is provided. In instances, a notification is sent to the consumer that no more deals are responsive and prompts for a new search.

Alternatively, the first subset includes a number of offers presented in order based on the value of the offers. In these examples, the size of the promotional offers and type of consumer device determines the number of promotional offers to be sent. In other examples, a combination of the value of the offer and additional factors may be combined to determine the order in which promotional offers are provided to the consumers. For example, a first subset of promotional offers may be sequenced based a combination of the value of the offer and the geographic proximity of the offer. In one example, the complete group of matched offers encompasses seafood restaurants within a 20-mile radial proximity. The first set of matched offers includes offers within five miles of the consumer with a value of $0.50 or more. The promotional offers within the 5-mile radius are displayed in order based on value until each promotional offer valued at $0.50 or more and within a five mile radius is displayed. Thereafter, the promotional offers are grouped first according to those offers within ten miles of the consumer and ultimately fifteen miles of the consumer.

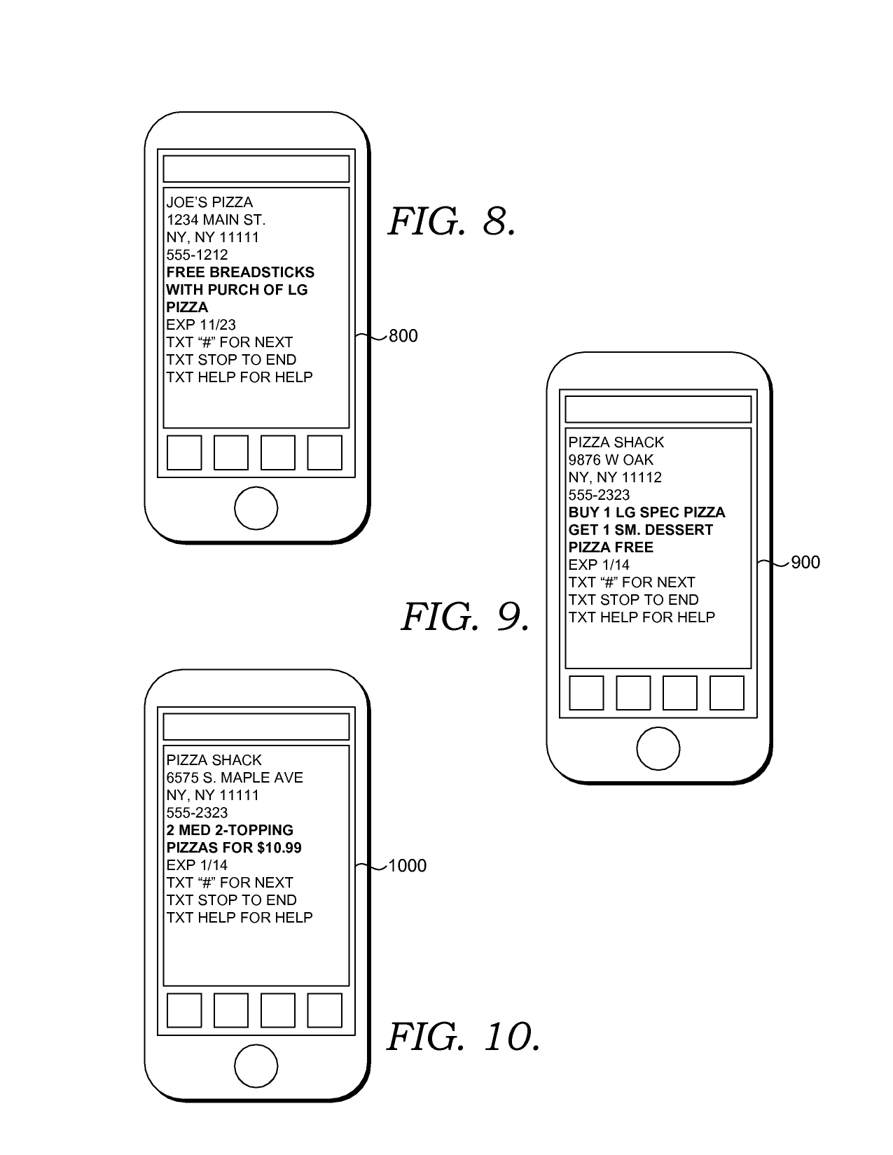

As discussed above, each promotional offer is associated with one or more keywords. Likewise, a common deal may be associated with multiple locations of a business. Also, a business or a single location of a business may offer a number of promotional offers. With reference to FIG. 7, an exemplary relationship of promotional offers associated with a plurality of businesses and locations is shown. For example, a first business 702 includes a single location and a single promotional offer 720 associated with the business and its location. With reference to FIG. 8, a screen display 800 displays a promotional offer for “Joe's Pizza”.

With reference back to FIG. 7, a second business 710 includes a first location 711 and a second location 712. The business may define different offers to be provided to consumers for different locations. A promotional offer 725 is associated with the first location 711 but not the second location. With reference to FIG. 9, a screen display 800 displays a promotional offer (“BUY 1 LG SPEC PIZZA GET 1 SM. DESSERT PIZZA FREE”) for the first location (“9876 W OAK; NY, N.Y. 11112”) for the second business (“PIZZA SHACK”). Likewise, a promotional offer 730 is associated with the second location 712 but not the first location 711. With reference to FIG. 10, a screen display 1000 displays a promotional offer (“2 MED 2-TOPPING PIZZAS FOR $10.99”) for the second location (“6575 S. MAPLE AVE; NY, N.Y. 11111”).

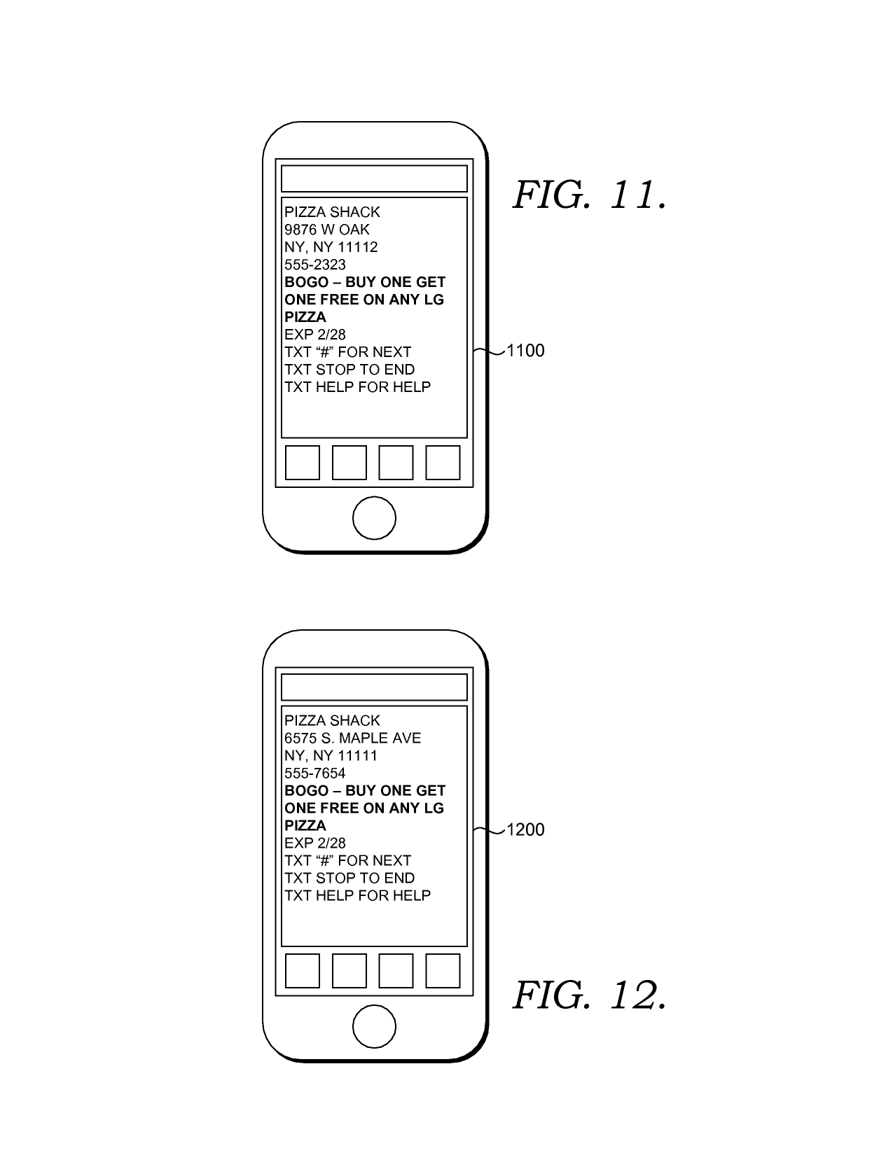

Likewise, a multi-location business may define common offers to be provided to the consumers for multiple locations. With reference to FIG. 7, a deal 735 with common offer terms apply to each of the multiple locations 711, 712 of the business 710. With reference to FIG. 11, an exemplary display 1100 for a common deal (“BOGO—BUY ONE GET ONE FREE ON ANY LG PIZZA”) is associated with the first location (“9876 W OAK; NY, N.Y. 11112”). With reference to FIG. 12, an exemplary display 1200 for the common deal (“BOGO—BUY ONE GET ONE FREE ON ANY LG PIZZA”) is also associated to the second location (“6575 S. MAPLE AVE; NY, N.Y. 11111”). In examples, each of the promotional offers represented in FIGS. 8-12 are associated with the keyword “PIZZA”. Upon receipt of a consumer-initiated text request for “PIZZA”, the promotional offers are sequenced according to the advertisement value of each offer and the location of the consumer as described above.

In examples, web applications and mobile phone applications are utilized in connection with the promotional offer database of the present invention. Further, these corresponding applications may be utilized to register consumers for the text messaging service of the present invention and to obtain contextual information about the consumer.

Examples of the present invention provide coupons and other promotional offers upon demand of the consumer. Accordingly, the consumer does not receive unwanted and untimely text messages for undesirable products and services. In examples, geographic relevance is considered so the user does not have to sort through offers with limited interest to the consumer. The use of a common address or short code for products and services in a variety of business sectors improves the user experience and lowers the costs associated with promoting text-based coupons for businesses. In examples, the requests are freely formed by the consumer so the text-based promotional offers are easy to request and receive. The system and methods are easy for consumers to initiate, navigate and conclude.

Likewise, sellers have flexibility in developing the promotional offers. The advertising cost for the promotional offers is tied directly to those promotional offers viewed by consumers. In examples, the advertising value is market-based to ensure the price to the advertiser is appropriate. In other examples, the database of the present invention provides for analytics regarding consumer buying patterns and preferences.

As can be understood, the present invention provides systems, methods, and user interfaces for electronically generating and providing promotional offers to a mobile device. The present invention has been described in relation to particular examples, which are intended in all respects to be illustrative rather than restrictive. Alternative examples will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

1. One or more computer storage media having computer-executable instructions embodied thereon, that when executed, perform a method for electronically generating and providing promotional offers to a mobile device, the method comprising:
receiving a plurality of consumer-initiated text messages directed to a common code, wherein each consumer-initiated text message includes a consumer request from a consumer; and
for each consumer-initiated text message,
identifying a plurality of promotional offers matching the consumer request from a group of promotional offers for a number of businesses,
sending a first promotional text message to the consumer, the first text message to the consumer including a first subset of the matched promotional offers, wherein at least one promotional offer in the first set is from a first business, and
in response to a first reply text message from the consumer, sending a second promotional text message to the consumer, the second text message to the consumer including a second subset of the matched promotional offers, wherein at least one promotional offer in the second set is from a second business.

2. The media of claim 1, wherein the common code is a short code.

3. The media of claim 1, wherein each promotional offer is associated with a geographic area.

4. The media of claim 3, further comprising filtering the matched promotional offers, wherein the filtering compares a geographical location of the consumer to the geographic area of the matched promotional offers.

5. The media of claim 1, wherein identifying a plurality of promotional offers matching the consumer request includes selecting promotional offers linked to one or more keywords.

6. The media of claim 1, wherein each of the promotional offers is associated with an advertisement value.

7. The media of claim 6, wherein the advertisement value of each of the promotional offers in the first subset exceeds the advertising value of each of the promotional offers in the second subset.

8. The media of claim 1, further comprising determining if the consumer-initiated request is from a consumer registered to receive promotional offers.

9. The media of claim 7, further comprising, in response to a second reply text message from the consumer, sending a third promotional text message to the consumer, the third text message to the consumer including a third subset of the matched promotional offers.

10. The media of claim 9, wherein the advertisement value of each of the promotional offers in the second subset exceeds the advertising value of each of the promotional offers in the third subset.

11. The media of claim 1, wherein each promotional offer includes a graphical representation of a coupon.

12. The media of claim 1, further comprising sending an initial text message to the consumer requesting additional information, and, in response to a reply to the initial text message, determining a business sector for the consumer-initiated request.

13. The media of claim 12, wherein matching the consumer requests includes identifying promotional offers for the determined business sector.

14. One or more computer storage media having computer-executable instructions embodied thereon, that when executed, perform a method for electronically generating and providing promotional offers to a mobile device, the method comprising:
storing a plurality of promotional offers, wherein each promotional offer includes one or more keywords, an advertisement value of each keyword, a geography associated with the offer, and the content of the offer;
in response to a first consumer-initiated text message request to a common code, identifying a plurality of promotional offers matching the request by determining if the first consumer-initiated text message request includes a keyword associated with one or more of the promotional offers,
filtering the identified promotional offers based on a location of the consumer;
sending a first subset of the identified promotional offers to the consumer;
in response to a consumer-initiated text message reply, sending a second subset of identified promotional offers to the consumer, wherein the advertisement value of each of the promotional offers in the first subset exceeds the advertisement value of each of the promotional offers in the second subset.

15. The media of claim 14, wherein the common code is a short code.

16. The media of claim 15, wherein the geography associated with each offer is defined as a radius from a specific point.

17. One or more computer storage media having computer-executable instructions embodied thereon, that when executed, perform a method for electronically generating and providing promotional offers to a mobile device, the method comprising:
receiving a plurality of consumer-initiated text messages directed to a common code, wherein each text message includes a consumer-defined request from a consumer; and
for each consumer-initiated text message,
identifying a plurality of promotional offers matching the consumer-defined request from a group of promotional offers for a number of locations,
sending a first promotional text message to the consumer, the first text message to the consumer including a first subset of the matched promotional offers, wherein at least one promotional offer in the first set is from a first business, and
in response to a first reply text message from the consumer, sending a second promotional text message to the consumer, the second text message to the consumer including a second subset of matched promotional offers, wherein at least one promotional offer in the second set is from a second business.

18. The media of claim 17, wherein the common code is a short code.

19. The media of claim 17, wherein the first business includes a first location and a second location, and wherein the first promotional offer is associated with the first location.

20. The media of claim 19, further comprising sending a third promotional text message to the consumer, the third text message including a third subset of the matched promotional offers, wherein at least one promotional offer in the third subset is associated with the second location of the first business.
